(19) United States
(12) Patent Application Publication
(10) Pub. No.: US 2026/0184401 A1
(43) Pub. Date: Jul. 2, 2026

(54) Assembly for Actuating a Shift Element of a Transmission

(71) Applicant: ZF Friedrichshafen AG, Friedrichshafen (DE)

(72) Inventors: Hagen Doepfert, Lindau (DE); Peter Ziemer, Bad Woerishofen (DE); Thomas Riedisser, Sigmarszell (DE); Ulrich Doerr, Konstanz (DE); Uwe Schraff, Markdorf (DE); Markus Strobel, Ravensburg (DE); Christoph Margraf, Markdorf (DE); Uwe Griesmeier, Markdorf (DE); Leschek Debernitz, Eriskirch (DE); Michel Wiemer, Weingarten (DE); Michael Bucher, Friedrichshafen (DE)

(21) Appl. No.: 18/835,392

(22) PCT Filed: Feb. 1, 2023
(86) PCT No.: PCT/EP2023/052374

§ 371 Date: Aug. 2, 2024

(30) Foreign Application Priority Data
Feb. 3, 2022 (DE) 10 2022 201 130.9

(51) Int. Cl. B62M 25/00; B62M 11/14; F16H 63/18; F16H 63/32

(52) U.S. Cl. CPC B62M 25/00; F16H 63/18; B62M 11/145; F16H 2063/325

(57) ABSTRACT

An arrangement for actuating a shift element includes a shift pawl (3) pivotably mounted about a pivot axis (2) and a rotatable shift ring (4) with an outer toothing (5). A first end (6) of the shift pawl (3) is assigned to the outer toothing (5) of the shift ring (4), and a second end (7) of the shift pawl (3) is assigned to a shift gate (8) that actuates the shift pawl (3). A first contact line region (10) between a contact surface course (11) on the first end of the shift pawl (3) and a contact surface course (12) on the outer toothing (5) of the shift ring (4) is designed such that a contact engagement angle (φ) of the shift pawl (3) of approximately 94° plus/minus 3° is produced between a first leg and a second leg.

### CROSS-REFERENCE TO RELATED APPLICATIONS

The present application is related and has right of priority to German Patent Application No. DE 102022201130.9 filed on Feb. 3, 2022, and is a U.S. national phase of PCT/EP2023/052374 filed on Feb. 1, 2023, both of which are incorporated by reference in their entireties for all purposes.

### TECHNICAL FIELD

The present invention relates generally to an arrangement for actuating a shift element of a gearbox, in particular of a bottom bracket gearbox. The invention further relates generally to a bottom bracket gearbox having the arrangement and to a bicycle or pedelec having the bottom bracket gearbox.

### BACKGROUND

For example, the publication DE 10 2019 220 044 A1 describes a bottom bracket gearbox in a planetary gear set design for a bicycle or a pedelec having an arrangement for actuating at least one brake shift element. The bottom bracket gearbox has multiple planetary gear sets for implementing various gear stages. The bottom bracket gearbox is assigned multiple brake shift elements, each of which has a brake ring that is assigned to a gearbox component and can be locked or released via a brake pawl in order to implement a predetermined associated gear stage. The brake rings of the brake shift elements are each rotatably mounted in the housing of the bottom bracket gearbox. Each brake pawl assigned to a brake ring is actuated by a rotatably mounted shift drum, which is arranged approximately axially parallel to a central axis of rotation of the bottom bracket gearbox. To lock the brake ring, the brake pawl is brought into engagement with an outer toothing of the brake ring. As a result, corresponding reaction and actuating forces arise at the brake pawl and at the shift drum. Due to these forces, a correspondingly high shift torque is required, which strains the actuation of the shift drum and the shift pawl.

### BRIEF SUMMARY

Example aspects of the present invention provide an arrangement and a bottom bracket gearbox as well as a bicycle and a pedelec, in which an ability to shift under load with the lowest possible shift torque is made possible.

Example aspects of the invention therefore relates to an arrangement for actuating a shift element, in particular a brake shift element of a gearbox, in particular of a bottom bracket gearbox, having a shift pawl, in particular a brake pawl, which is pivotably mounted about a pivot axis, and having a rotatable shift ring, in particular a brake ring, which has an outer toothing and is assigned to a gearbox element. A first end of the shift pawl is assigned to the outer toothing of the shift ring so as to lock or release the shift ring in order to shift a gear stage and a second end of the shift pawl is assigned to a shift gate having an alternately rising and falling course on an outer circumference of a shift drum that actuates the shift pawl. In order to permit shifting under load with the lowest possible shift torque, a first contact line region between a contact surface course on the first end of the shift pawl and a contact surface course on the outer toothing of the shift ring is designed such that a contact engagement angle φ of the shift pawl of approximately ninety-four degrees (94°) plus/minus three degrees (3°) is produced between a first leg, in the form of a connection between the first contact line region and the pivot axis of the shift pawl, and a second leg, in the form of a tangent to the contact surface course in the first contact line region.

Due to the contact engagement angle φ provided in the arrangement according to example aspects of the invention, the reaction and actuating forces occurring on the shift pawl are so low that a uniform shift torque or actuation torque over the shift process at the lowest possible level is ensured and, in addition, no peaks occur in the shift torque curve. Consequently, an ability to shift under load can be realized in the arrangement according to example aspects of the invention.

Within the framework of example aspects of the present invention, it is provided that the contact surface course on the first end of the shift pawl is in the form of an approximate involute course.

For example, the at least approximate involute course results on the first end of the shift pawl in the arrangement according to example aspects of the invention when the central point of the radius of the contact surface course is located on the first end of the shift pawl on a leg line through the pivot axis of the shift pawl, wherein the leg line is located at an angle β of ninety degrees (90°) plus/minus ten degrees (10°) to a connection from the first contact line region to the pivot axis of the shift pawl.

In the arrangement according to example aspects of the invention, it can be preferably provided that the contact surface course on the outer toothing of the shift ring forms approximately a plane and thus has no radius. However, it is also possible for the contact surface course on the outer toothing of the shift ring to correspond to an involute or at least an approximate involute.

The configurations provided for the contact surface courses of the first contact line region between the first end of the shift pawl and the outer toothing of the shift ring ensure that the first contact line region is assigned to the tooth tip of the outer toothing. As a result, a tooth tip carrier is more or less implemented as an outer toothing on the shift ring.

In order to also optimize a second contact line region between a contact surface course on the second end of the shift pawl and a contact surface course on the alternately rising and falling course of the shift gate on the shift pawl, the contact surface course on the shift gate is in the form of an at least approximate involute course. Consequently, an approximate or actual involute course can be provided.

For example, this, for example approximate, involute course results on the shift drum in the arrangement according to the invention when the central point of the radius of the contact surface course on the shift gate is located on a leg line through the pivot axis of the shift pawl, the leg line forming an angle μ of approximately ninety degrees (90°) plus/minus five degrees (5°) to a perpendicular bisector on the connection between an extreme innermost contact line and an extreme outermost contact line of the second contact line region on the contact surface course of the shift gate.

In order to permanently ensure the ability to shift under load in the arrangement according to example aspects of the invention, the shift drum and the shift pawl are made of hardened steel or from an aluminum alloy having a hard-anodized surface. Within the framework of example aspects of the invention, it can be provided that the shift pawl is in the form of a rocker arm or a cam follower. Rocker arms are in the form of double-sided levers, while cam followers are in the form of a single-sided lever.

In order to optimize the lubrication and thus the oil supply of the shift drum in the arrangement according to example aspects of the invention, the shift drum is assigned to an oil sump of the gearbox. In this way, a sufficient amount of oil is available to lubricate the shift drum.

A further example aspect of the invention claims a bottom bracket gearbox having at least one above-described arrangement for actuating shift elements, in particular brake shift elements, resulting in the above-described advantages and further advantages.

A next example aspect of the invention claims a bicycle or pedelec having the above-described bottom bracket gearbox, resulting in the above-described advantages and further advantages.

### BRIEF DESCRIPTION OF THE DRAWINGS

Example aspects of the present invention are explained in greater detail in the following with reference to the drawings, wherein:

FIG. 1 shows a schematic sectional partial view of one possible embodiment variant of an arrangement according to example aspects of the invention for actuating a shift element of a gearbox;

FIG. 2 shows an enlarged detailed view of a first contact line region between a contact surface course on a first end of a shift pawl and a contact surface course on an outer toothing of a shift ring of the example arrangement;

FIG. 3 shows a detailed view of the shift pawl according to FIG. 1 engaged in the outer toothing of the shift ring;

FIG. 4 shows a further detailed view of the shift pawl according to FIG. 1 engaged in the outer toothing of the shift ring; and

FIG. 5 shows an enlarged detailed view of a second contact line region between a contact surface course on a second end of the shift pawl and a contact surface course on a shift gate of a shift drum actuating the shift pawl according to FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

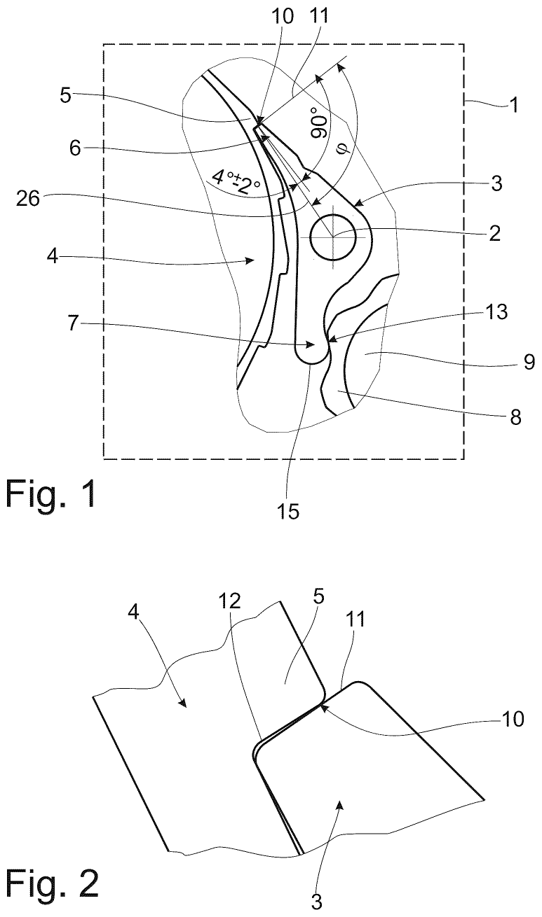

In FIGS. 1 through 5 one possible embodiment variant of an arrangement according to example aspects of the invention for actuating a shift element which is in the form, for example, of a brake shift element, is shown as an example, preferably on the basis of a bottom bracket gearbox of a bicycle or pedelec 1.

The arrangement includes a shift pawl, or brake pawl 3, which is pivotably mounted about a pivot axis 2, and a rotatable shift ring, or brake ring 4, which has an outer toothing 5 and is assigned to a gearbox element. A first end 6 of the shift pawl 3 is assigned to the outer toothing 5 of the shift ring 4 so as to lock or release the shift ring 4 in order to shift a gear stage. A second end 7 of the shift pawl 3 is assigned to a shift gate 8 having an alternately rising and falling course on an outer circumference of a shift drum 9 that actuates a shift pawl 3. The rising and falling course is realized by a ramp-shaped, recurring peak-and-valley shape on the shift drum 9 in the form of a shift gate 8.

In order to permit an ability to shift under load with the most uniform shift torque curve possible using the arrangement according to example aspects of the invention, a first contact line region 10 between a contact surface course 11 on the first end 6 of the shift pawl 3 and a contact surface course 12 on the outer toothing 5 of the shift ring 4 is designed such that a contact engagement angle φ of the shift pawl 3 of approximately ninety-four degrees (94°) plus/minus three degrees (3°) is produced between a first leg, in the form of a connection 26 between the first contact line region 10 and the pivot axis 2 of the shift pawl 3, and a second leg, in the form of a contact surface course 11 on the first contact line region 10.

With the contact engagement angle φ according to example aspects of the invention, as is shown in FIG. 1, the ability to shift under load is realized, in particular when downshifting from a higher gear into a lower gear. In addition, the reaction and actuating forces on the shift pawl are relatively low due to the selected contact engagement angle φ. In addition, the torque level is reduced overall to a minimum value due to the uniform actuating torque over the disengagement process of the shift pawl 3, since no torque peaks occur during the course of the shifting process.

It is also apparent from FIG. 1 that, at the selected contact engagement angle φ, the connection 26 between the first contact line region 10 and the pivot axis 2 of the shift pawl 3 is shifted by an angle of four degrees (4°) plus/minus two degrees (2°), and therefore a further ninety degrees (90°) results in the optimal contact engagement angle φ of ninety-four degrees (94°) plus/minus two degrees (2°).

According to FIG. 2, the first contact line region 10 between the shift pawl 3 and the shift ring 4 is preferably designed such that a tooth tip carrier results on the shift ring 4. The tolerances for the inclination of the contact surface course 11 on the first end 6 of the shift pawl 3 and for the inclination of the contact surface course 12 on the outer toothing 5 of the shift ring 4 are selected such that surface contact results between the shift ring 4 and the shift pawl 3 only in the extreme case (tooth tip carrier and tooth root carrier at the same time), but otherwise a tooth tip carrier is realized. As a result, the contact conditions remain constant over the entire disengagement process and there is no or only a minimal displacement of the contact line at the first contact line region 10.

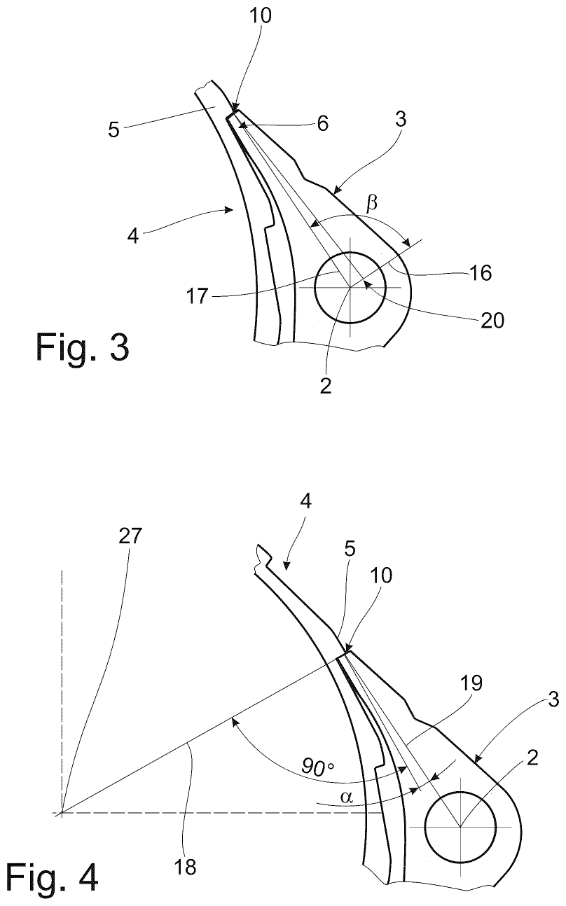

The contact surface course 11 on the first end 6 of the shift pawl 3 is preferably in the form of an involute course or at least in the form of an approximate involute course. As a result, the required shift torque is held constant over the entire disengagement process. At least one approximate involute results as a contact surface course 11 when the central point of the radius 20 of the contact surface course 11 on the first end 6 of the shift pawl 3 is located on a leg line 16 which is situated at the angle β of ninety degrees (90°) plus/minus ten degrees (10°) to the connection 17 from the first contact line region 10 between the shift pawl 3 and the shift ring 4 on the contact surface course 11 to the pivot axis 2 of the shift pawl 3, as is shown in FIG. 3.

The contact surface course 12 on the outer toothing 5 of the shift ring 4 is preferably in the form of a plane. However, it is conceivable that the shape of the contact surface course 12 is also in the form of an involute or at least an approximate involute.

FIG. 4 shows a connection 18 from a rotation axis 27 of the shift ring 4 to the first contact line region 10 as a first leg and a connection 19 from the first contact line region 10 to the pivot axis 2 of the shift pawl 3 as a second leg, with the connection 19 starting from the first leg at an angle of ninety degrees (90°) plus the angle α. The smallest possible value of the angle α ensures that contact forces at the first contact line region 10 will be as low as possible. However, the angle α can also be increased, as a result of which it becomes possible to increase the number of teeth on the outer toothing 5 of the shift ring 4. As a result, the idle travel on the pedal of the bicycle or pedelec 1 can be reduced.

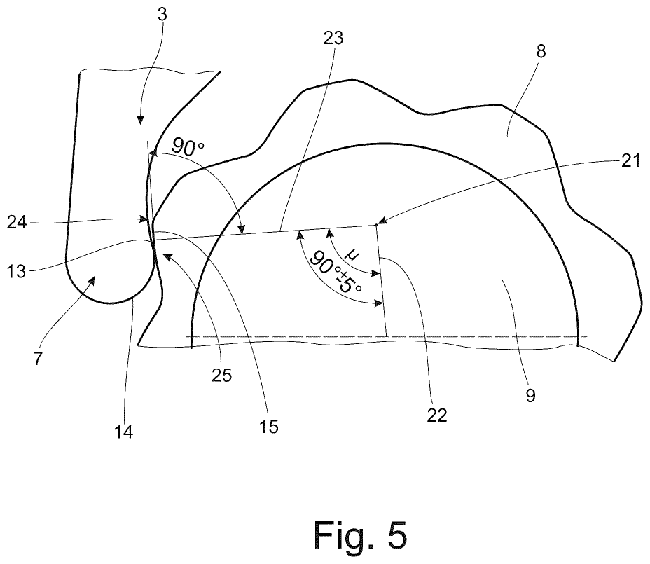

In FIG. 5 the second contact line region 13 between the second end 7 of the shift pawl 3 and the shift gate 8 on the shift drum 8 is shown in detail. The shift gate 8 has an alternately rising and falling course on the outer circumference of the shift drum 9. This ramp-shaped course is realized by the transitions from valley to peak on the shift gate 8. The disengagement ramp, or the rising course, to disengage the shift pawl 3 in the transition from a valley to a peak on the shift gate 8 is preferably in the form of an approximate involute shape in both directions. The central point of the radius 21 of the contact surface course 15, which is shown in detail, on the shift gate 8 for disengaging the shift pawl 3 lies on a leg line 22 which extends through the pivot axis 2 of the shift pawl 3 and forms an angle μ of approximately ninety degrees (90°) plus/minus five degrees (5°) to the perpendicular bisector 23 on the second contact line region 13 between the two extreme outermost and innermost contact lines 24, 25.

The contact surface course 14 on the second end 7 of the shift pawl 3 is preferably a circular surface. It is conceivable that the contact surface course 14 on the shift pawl 3 also forms an involute course or at least an approximate involute course.

Due to the provided courses on the first contact line region 10 between the shift pawl 3 and the shift ring 4 as well as on the second contact line region 13 between the shift pawl 3 and the shift gate 8, a uniformity of the shift torque curve over the gear ratio change at the shift pawl 3 and the shift drum 9 is realized in a particular way and thus the required twisting moment of the shift drum 9 during the gear ratio change is reduced, the shifting comfort is increased and, simultaneously, the wear on the shift pawl 3 and the shift drum 9 is reduced.

The shift drum 9 and the shift pawl 3 are preferably made of an aluminum alloy that is hard-anodized on the surface, in order both to reduce weight and to optimize the tribological antifrictional properties.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 bicycle or pedelec
2 pivot axis of of the shift pawl
3 shift pawl, or brake pawl
4 shift ring, or brake ring
5 outer toothing
6 first end of the shift pawl
7 second end of the shift pawl
8 shift gate
9 shift drum
10 first contact line region between shift pawl and shift ring
11 contact surface course on the first end of the shift pawl
12 contact surface course on the outer toothing of the shift ring
13 second contact line region between shift pawl and shift gate
14 contact surface course on the second end of the shift pawl
15 contact surface course on the shift gate
16 leg line through the rotation axis of the shift pawl
17 connection from the first contact line region to the pivot axis of the shift pawl
18 connection from a rotation axis of the shift ring to the first contact line region
19 connection between the first contact line region and the pivot axis
20 central point of the radius of the contact surface course on the first end of the shift pawl
21 central point of the radius of the contact surface course on the shift gate
22 leg line through the pivot axis of the shift pawl
23 perpendicular bisector on the second contact line region on the contact surface course of the shift gate
24 extreme, or outermost, contact line of the second contact line region
25 extreme, or innermost, contact line of the second contact line region
26 connection of the first contact line region with the rotation axis of the shift pawl
27 rotation axis of the shift ring
α angle
β angle
φ contact engagement angle
μ angle

1-15. (canceled)

16. An arrangement for actuating a shift element of a gearbox, comprising:
a shift pawl (3) pivotably mounted about a pivot axis (2); and
a rotatable shift ring (4) comprising an outer toothing (5) and assigned to a gearbox element,
wherein a first end (6) of the shift pawl (3) is assigned to the outer toothing (5) of the shift ring (4) so as to lock or release the shift ring (4) in order to shift a gear stage,
wherein a second end (7) of the shift pawl (3) is assigned to a shift gate (8) comprising an alternately rising and falling course on an outer circumference of a shift drum (9) that actuates the shift pawl (3),
wherein a first contact line region (10) between a contact surface course (11) on the first end of the shift pawl (3) and a contact surface course (12) on the outer toothing (5) of the shift ring (4) is configured such that a contact engagement angle (φ) of the shift pawl (3) is no less than ninety-one degrees and no greater than ninety-seven degrees, the contact engagement angle (φ) defined between a first leg and a second leg, the first leg formed by a connection (26) between the first contact line region (10) and the pivot axis (2) of the shift pawl (3), the second leg formed by a tangent to the contact surface course (11) in the first contact line region (10).

17. The arrangement of claim 16, wherein the contact surface course (11) on the first end (6) of the shift pawl (3) forms an approximate involute course.

18. The arrangement of claim 17, wherein:
the at least approximate involute course is defined by the central point of the radius (20) of the contact surface course (11) being located on the first end (6) of the shift pawl (3) on a leg line (16) through the pivot axis (2) of the shift pawl (3); and
the leg line (16) is located at an angle (β) that is no less than eighty degrees and no greater than one hundred degrees to a connection (17) from the first contact line region (10) to the pivot axis (2) of the shift pawl (3).

19. The arrangement of claim 16, wherein the contact surface course (12) on the outer toothing (5) of the shift ring (4) forms a plane.

20. The arrangement of claim 16, wherein the contact surface course (12) on the outer toothing (5) of the shift ring (4) corresponds to a course of an involute or an approximate involute.

21. The arrangement of claim 16, wherein the first contact line region (10) is assigned to the tooth tip of the outer toothing (5).

22. The arrangement of claim 16, wherein the shift pawl (3) comprises a rocker arm or a cam follower.

23. The arrangement of claim 16, wherein:
a second contact line region (13) is provided between a contact surface course (14) on the second end (7) of the shift pawl (3) and a contact surface course (15) on the shift gate (8); and
the contact surface course (15) on the shift gate (8) along the rising or falling course is in the form of an at least approximate involute course.

24. The arrangement of claim 23, wherein:
the approximate involute course on the contact surface course (15) on the shift gate (8) is defined by the central point of the radius (21) of the contact surface course (15) on the shift gate (8) being located on a leg line (22) through the pivot axis (2) of the shift pawl (3); and
the leg line (22) is located at an angle (μ) of no less than eighty-five degrees and no greater than ninety-five degrees to a perpendicular bisector (23) on the connection between an innermost contact line (25) and an outermost contact line (24) of the second contact line region (13) on the contact surface course (15) of the shift gate (8).

25. The arrangement of claim 23, wherein the contact surface progression (14) on the second end (7) of the shift pawl (3) forms a circular radius course.

26. The arrangement of claim 23, wherein the contact surface course (14) on the second end (7) of the shift pawl (3) corresponds to a course of an involute or an approximate involute.

27. The arrangement of claim 16, wherein the shift drum (3) and the shift pawl (4) are made of hardened steel or an aluminum alloy with a hard-anodized surface.

28. The arrangement of claim 16, wherein the shift drum (3) is assigned to an oil sump of the gearbox.

29. A bottom bracket gearbox, comprising at least one arrangement of claim 16.

30. A bicycle or pedelec (1), comprising the bottom bracket gearbox of claim 29.
